(19) United States
(12) Patent Application Publication
(10) Pub. No.: US 2008/0079286 A1
(43) Pub. Date: Apr. 3, 2008

(54) SYSTEMS AND METHODS FOR REMOTELY CONFIGURING A REMOTE INTERFACE TO AN IMAGING DEVICE

(75) Inventors: Andrew Rodney Ferlitsch, Camas, WA (US); Stephen W. Ellis, Portland, OR (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc., Camas, WA (US)

(21) Appl. No.: 11/537,414

(22) Filed: Sep. 29, 2006

(51) Int. Cl. B62D 25/02

(52) U.S. Cl. 296/186.1

(57) ABSTRACT

In accordance with an embodiment, a remote process may generate a script that includes instructions for performing at least one operation on a local client. The remote process may be running on a remote device that is separate from the local client. The remote process may send the script as an imaging job to a remote imaging interface installed on the local client. The remote imaging interface may be associated with a script interpreting despooling component. A spooler on the local client may despool the script to the script interpreting despooling component. The script interpreting despooling component may interpret the instructions within the script and perform the at least one operation based on the interpreted instructions.

### TECHNICAL FIELD

The present invention relates generally to computers and computer-related technology. More specifically, the present invention relates to systems and methods for remotely configuring a remote interface to an imaging device.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, a typical desktop computer, such as an IBM-PC compatible, etc.

Printers are used with computers to print various kinds of items including letters, documents, pictures, etc. Many different kinds of printers are commercially available. Ink jet printers and laser printers are fairly common among computer users. Ink jet printers propel droplets of ink directly onto the paper. Laser printers use a laser beam to print.

Printers are a type of imaging device. Imaging devices include, but are not limited to, physical printers, multi-functional peripherals (MFPs), a printer pool, a printer cluster, a fax machine, a plotter, a scanner, a logical device, an electronic whiteboard, a tablet PC, a computer monitor, a file, a format conversion device, etc. The term “imaging,” as used herein, should be interpreted broadly to include any process for producing a copy of a document onto paper, a computer screen, an electronic image, or the like.

Different kinds of computer software facilitate the use of imaging devices. The computer or computing device that will be used to image (e.g., print) the materials typically has one or more pieces of software running on the computer that enable it to send the necessary information to the imaging device to enable the materials to be imaged. If the computer or computing device is on a computer network there may be one or more pieces of software running on one or more computers on the computer network that facilitate imaging.

Imaging devices may support both walk-up and remote interfaces. A remote interface may include device drivers and other associated imaging components. From time to time, these remote interfaces may need to be configured or reconfigured. These remote interfaces may be designed to be configured/reconfigured locally at the client device, but not necessarily designed to be easily and conveniently configured/reconfigured remotely. Therefore, there is a desire for a convenient and effective method for a printer administration utility (PAU) to remotely configure/reconfigure remote interfaces (e.g., installed printers) to an imaging device.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates an exemplary operating environment in which embodiments may be practiced;

FIG. 2 illustrates some aspects of the operation of a management/job generation process on a remote device in accordance with an embodiment;

FIG. 3 illustrates some aspects of the operation of a script interpreting despooling component in accordance with an embodiment;

FIG. 4 illustrates some aspects of the operation of a script interpreting despooling component in accordance with an embodiment where the script includes instructions for transferring a file;

FIG. 5 illustrates some aspects of the operation of a script interpreting despooling component in accordance with an embodiment where the script includes instructions for reconfiguring print settings of an installed printer;

FIG. 6 illustrates some aspects of the operation of a script interpreting despooling component in accordance with an embodiment where the script includes instructions for reconfiguring spooler settings of an installed printer;

FIG. 7 illustrates some aspects of the operation of a script interpreting despooling component in accordance with an embodiment where the script includes instructions for distributing a printer driver for a locally or network connected printer;

FIG. 8 illustrates some aspects of the operation of a script interpreting despooling component in accordance with an embodiment where the script includes instructions for distributing a printer driver for scanning to a destination on a local client;

FIG. 9 illustrates a method for remotely configuring a remote interface to an imaging device in accordance with an embodiment; and

FIG. 10 illustrates various components that may be utilized in a computing device in accordance with an embodiment.

### DETAILED DESCRIPTION

A method for remotely configuring a remote interface to an imaging device is disclosed. In accordance with an embodiment, a remote process may generate a script that includes instructions for performing at least one operation on a local client. The remote process may be running on a remote device that is separate from the local client.

The remote process may send the script as an imaging job to a remote imaging interface. The remote imaging interface may be installed on the local client. The imaging job may be sent to a network queue on the local client. The network queue may be associated with the remote imaging interface.

To send the script as an imaging job to the remote imaging interface, the remote process may connect directly to a spooler on the local client. Alternatively, the remote process may spool the script to an imaging device that is installed on the remote device. The imaging device may be connected to the remote imaging interface on the local client. A spooler on the remote device may despool the script to the remote imaging interface on the local client.

The remote imaging interface may be associated with a script interpreting despooling component. The script interpreting despooling component may be a specialized print processor, a specialized port monitor, or the like. A spooler on the local client may despool the script to the script interpreting despooling component. The script interpreting despooling component may interpret the instructions within the script and perform the at least one operation based on the interpreted instructions.

The at least one operation performed by the script interpreting despooling component may include transferring a file to the local client. Alternatively, or in addition, the at least one operation performed by the script interpreting despooling component may include reconfiguring settings of an installed imaging device on the local client. In this case, the remote process may identify the installed imaging device. The remote process may also identify the settings of the installed imaging device to be reconfigured.

Alternatively, or in addition, the at least one operation performed by the script interpreting despooling component may include reconfiguring spooler settings of an installed imaging device on the local client. In this case, the remote process may identify the installed imaging device. The remote process may also identify the spooler settings of the installed imaging device to be reconfigured. This may involve generating an additional script which requests that the script interpreting despooling component respond with available spooler settings.

Alternatively, or in addition, the at least one operation performed by the script interpreting despooling component may include installing an imaging device and an associated imaging device driver on the local client. In this case, the remote process may identify the imaging device to be installed. The remote process may also identify the associated imaging device driver.

Alternatively, or in addition, the at least one operation performed by the script interpreting despooling component may include receiving scanned image data. The script interpreting despooling component may perform a post-processing operation on the scanned image data.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments of the disclosed invention(s),” unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

One method of reconfiguring an installed printer is demonstrated by the Microsoft Windows® Printing Preferences. In this method, the user chooses a printer from the printers folder. The user then right clicks on the printer icon to display a context menu. One of the selections on this menu is printing preferences. When the user selects this option, the printer driver configured with the installed printer displays the printer's property pages. The printer's property pages may be used to set the default settings of one or more of the printer's print options (e.g., duplex, staple, copies, etc). Once the user applies the new settings, any subsequent invocation of the installed printer is initialized with the new default settings.

Another method of managing an installed printer is demonstrated by the driver distribution feature of the Sharp Printer Administration Utility (PAU) 4.0. In this method, the PAU application can detect when a new printer is connected to the network. When a new printer is discovered, the operator has the option of distributing the printer driver and installation script to communicate with the printer to one or more users. The distribution may be done as an email attachment, and the email user identifiers may be obtained from a distribution list maintained by the PAU application. Upon receipt of the driver distribution email, the user has the option to extract the attachment and install the printer driver and create an installed printer by executing the attachment.

In accordance with another method for managing an installed printer, a user installs a specialized printer driver as an installed (logical) printer. The specialized printer driver has the capability of discovering other installed shared (network) printers on the network. When the user invokes the property pages of the specialized printer driver, the user has the option of requesting the driver to locate installed shared printers on other host/server devices. The user may also specify a filter, such as requesting only devices with duplex capabilities. The specialized driver may then locate installed shared printers matching the filter criteria by querying a printer directory service. A printer directory service is a service where an installed shared printer may be registered. The user may then be presented with a selection of discovered installed printers. If the user selects one, the specialized printer driver may then reconfigure itself as an installed network printer connection to the selected shared printer.

In accordance with another method for managing an installed printer, a specialized printer driver may be installed as an installed (logical) printer. The printer driver may be used to perform file transfer operations to a destination. In this method, when invoked, the printer driver may connect to a destination and upload a user interface (UI). The user may then select options from the destination's UI. Upon completion, the printer driver may send the file to the destination along with the destination UI selected options. The destination may then process and store the file according to the destination options.

At least some embodiments disclosed herein may relate to systems and methods for remotely configuring/reconfiguring a remote interface (e.g., an installed shared printer) to an imaging device (e.g., an MFP device). Additionally, the disclosed embodiments may facilitate a remote device requesting a host device to perform imaging-related operations.

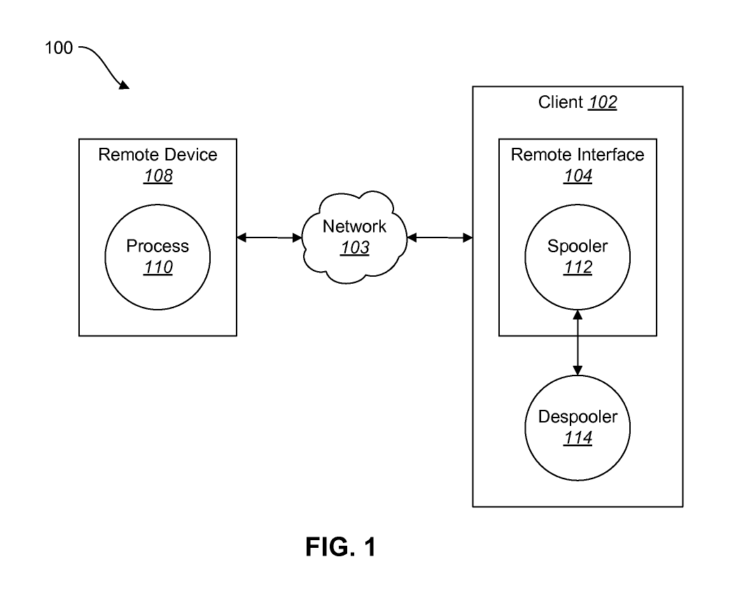

FIG. 1 illustrates an exemplary operating environment 100 in which embodiments may be practiced. An exemplary operating environment 100 may include one or more client devices (clients) 102. The clients 102 may be connected to a network 103.

The clients 102 may include a remote interface 104 to an imaging device 108, which may be referred to herein as a remote imaging interface 104. One example of a remote imaging interface 104 is an installed shared (logical) printer. Examples of shared (logical) printers include a Microsoft Windows installed shared (network) printer, a Novell Netware shared printer, etc.

The operating environment 100 may also include one or more remote devices 108. The remote devices 108 may also be connected to the network 103. The remote devices 108 may be printers, scanners, copiers, facsimile devices, filing devices, publishing devices, digital video cameras, digital audio recorders, electronic whiteboards, CD/DVD writers, client/server computing devices, format conversion devices, and so forth, including combinations thereof. The remote device(s) 108 may be capable of despooling an imaging job (e.g., a print job) to the remote imaging interface 104.

In accordance with an embodiment, a process 110 within a remote device 108 may be able to manage the remote imaging interface 104 and/or or request that the remote imaging interface 104 perform an imaging job or operation(s) related to an imaging job. Further, the remote process 110 may be able to accomplish this without the use of any additional protocol or background processes (i.e., those that are not already running on the local client 102).

The process 110 on the remote device 108 may be able to implement the above-described functionality by exploiting the pre-existence of a spooler 112 (e.g., a print spooler) on the local client 102 which may be constantly running and which may be able to receive what appears to be an imaging job for the remote imaging interface 104. However, instead of the remote imaging interface 104 being connected to a physical imaging device, the remote imaging interface 104 may be connected to a despooling component 114 (e.g., a specialized print processor or port monitor), which may be configured to perform management and imaging operations locally on the local client 102. This despooling component 114 may support interpreting a scripting language and performing operations locally based on interpreted script(s). These operations may include installing a new imaging device (e.g., printer), reconfiguring an existing installed imaging device (e.g., changing default settings), reconfiguring the spooling/despooling settings of a port monitor associated with an existing installed imaging device, receiving scanned image data and performing one or more post-processing operations (e.g., workflow), file transfer, loading an address book, and so forth.

In accordance with an embodiment, the process 110 on the remote device 108 may generate an imaging management or job script on the remote device 108 and send it to the local client 102 as an imaging job. The imaging job may be directed to a network queue on the local client 102 which may be associated with the remote imaging interface 104. The spooler 112 on the local client 102 may then despool the management/job script to the script interpreting despooling component 114. The script interpreting despooling component 114 may then interpret the script and perform the associated management/job operation(s) locally on the local client 102.

In some of the embodiments described below, the remote imaging interface 104 may be embodied as a shared (logical) printer 104. Although the description below may include some specific references to a shared (logical) printer 104 (and corresponding references to print spoolers, printers, etc.), embodiments disclosed herein are not limited in this regard, and may be utilized in connection with any remote imaging interface 104.

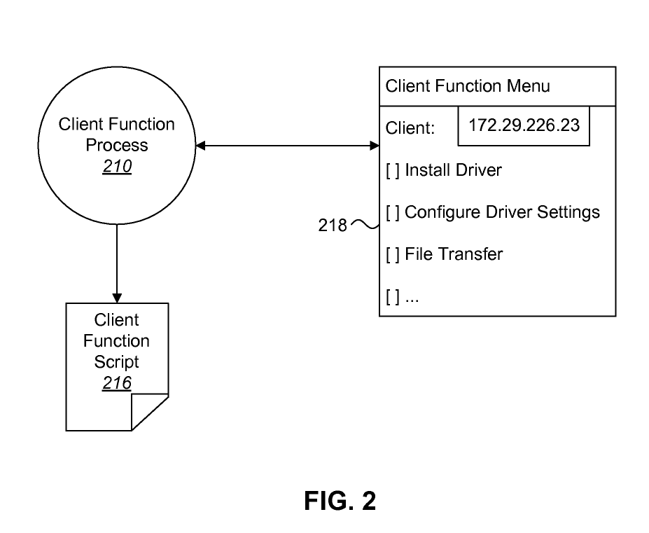

Referring now to FIG. 2, in accordance with an embodiment a management or imaging job generation process 210 may be running on a remote device 108. This process 210 may run either interactively or automatically. If the process 210 runs automatically, the process 210 may generate a management/job script 216 periodically, after the occurrence of specified events (event driven), and/or at predetermined times.

If the process 210 runs interactively, the user may interact with the management/job process 210. Interaction between the user and the management/job process 210 may occur via a user interface 218, such as a command line interface, a GUI interface on a computing device, a keyboard or touch screen interface on an imaging device, etc. From the interface 218 the user may identify the local client 102 and/or remote imaging interface 104, the management/job function and associated parameters. For example, the user may identify the local client 102 and request the management/job process 210 to discover the shared printer(s) 104 on the local client 102. Alternatively, the user may request the management/job process 210 to discover all local clients 102 with a shared printer 104.

The local client 102 may be identified by any suitable means, such as IP address, DNS/WINS name, etc. Additionally, the local client 102 may be automatically discovered by the device 108, such as using a device discovery protocol (e.g., SLP, SDDP, SNMP broadcast, network sweep, etc.). The shared printers 104 on the local client 102 may be identified by any suitable means. For example, in the Microsoft Windows® operating system, the remote device 108 may execute a Win32 EnumPrinters( ) API call to the print spooler 112 on the local client 102 to enumerate all shared printers 104 and associated printer information. Once enumerated, the associated printer information may be used to identify which of the shared printers 104 are configured to perform the desired management/job operation(s), such as by identifying the port monitor associated with the shared printer 104.

In the case of discovering all shared printers 104 on all local clients 102 within the (sub)network domain, the management/job process 210 may use any suitable device discovery technique(s). The management/job process 210 may then use the above method or use the Win32 EnumPrinters( ) API call to enumerate all shared printers 104 on all clients 102 within the network domain. The user may also specify the shared printer 104 directly, such as by providing the name of the shared printer 104 (e.g., \\server\shared_printer_name), the URL of the shared printer 104, etc.

The management/job function specified may be any suitable management/job function, such as installing a new printer (or other type of imaging device), reconfiguring (e.g., default settings) an existing installed printer, reconfiguring the spooling/despooling settings of a port monitor associated with an existing installed printer, receiving scanned image data and performing a post-processing operation (e.g., workflow), file transfer, loading an address book, format conversion, and so forth. The management/job process 210 may then generate a script 216 to perform the selected function(s) and associated parameters. The script 216 may be written in a scripting language (e.g., Javascript) that is understood by the script interpreter despooling component 114 on the local client 102.

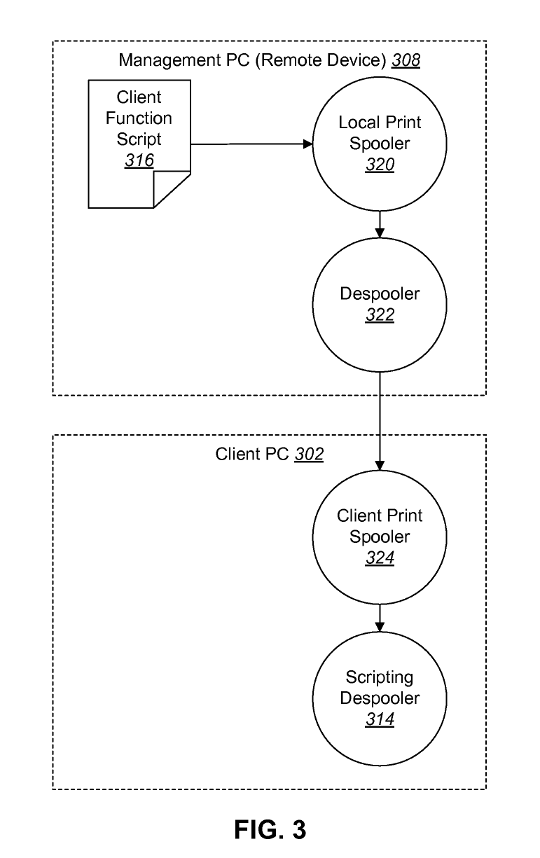

Referring now to FIG. 3, in accordance with an embodiment a remote device 308 may despool a management/job script 316 to the shared printer 104 of the local client 302. For example, if the remote device 308 is a computing device, one way to accomplish this is as follows. An installed network printer on the remote device 308 may be connected to the shared printer 104 on the local client 302. The management/job script 316 may be spooled to the installed network printer. A print spooler 320 and despooler 322 on the remote device 308 may despool the management/job script 316 to the shared printer 104 on the local client 302. Upon receipt, a print spooler 324 on the local client 302 may then despool the management/job script 316 (which may be queued to the shared printer 104) to the script interpreting despooling component 314 configured with the shared printer 104. Alternatively, the remote device 308 may also directly despool the management/job script 316 without the use of a local print spooler 320 and despooler 322 by connecting directly to the local client's print spooler 324, according to the communication address, port and protocol of the local client's print spooler 324.

As mentioned above, a script interpreting despooling component 114 may support interpreting instructions contained within a script 216 and performing operations locally based on the interpreted instructions. One example of an operation that may be performed is a file transfer. In particular, a management/job generation process 110 on the remote device 108 may be used to transfer a file to the local device 102. The source location of the file to transfer may either be local to the remote device 108, local to the local client 102, or remote from the remote device 108 and the local client 102.

When the file is local to the remote device 108, the file contents may either be embedded in the file transfer script 216, or a reference to the location may be specified, such as by a URL or a network file path. When the file is local to the local device 102, a reference to the file (e.g., local file path) may be embedded in the script 216. When the file is remote to both the remote device 108 and the local client 102, the remote device 108 may either pull the file and embed the file contents or embed a reference to the file.

The script 216 may also include information about where on the local device 102 the file is to be transferred. For example, the script 216 may indicate that the file is to be transferred to a local folder or directory, to a specific file path, to a location that is remote to the local device 102, etc. If the script 216 does not indicate where the file is to be transferred, the file may be transferred to a default folder.

The script 216 may also include other parameters (e.g., workflow), such as file format conversion, encryption (symmetric, public/private key), compression (RLE, LZW, JPEG, etc), OCR, Bates stamping and/or time stamping, etc. In some cases, some or all of the above parameters may be performed by the remote device 108 or deferred to the local client 102. The generation process may also attempt to determine the capabilities of the local client's script interpreting despooler component 114. This may be done by generating an additional job script which requests the local client's script interpreting despooler component 114 to respond back with its capabilities. Alternatively, the capabilities of the local client's script interpreting despooler component 114 may be predetermined.

The script interpreting despooling component 114 (e.g., print processor or port monitor) may have the capability to interpret and execute the functions specified in the script 216. These functions may include extracting the file contents; pulling the file contents, such as from a network file path or HTTP or SOAP/DIME request; compressing or decompressing the file contents; encrypting or decrypting the file contents; converting and/or re-encoding the file contents; storing the file contents at the specified location; optical character recognition (OCR) and indexing; annotation and time stamping; auditing and other logging; accounting; and so forth. Additionally, the script interpreting despooling component 114 may send back notifications to the remote client function process 210, 320, 322 indicating the status of performing the task, such as the start of the task and completion status.

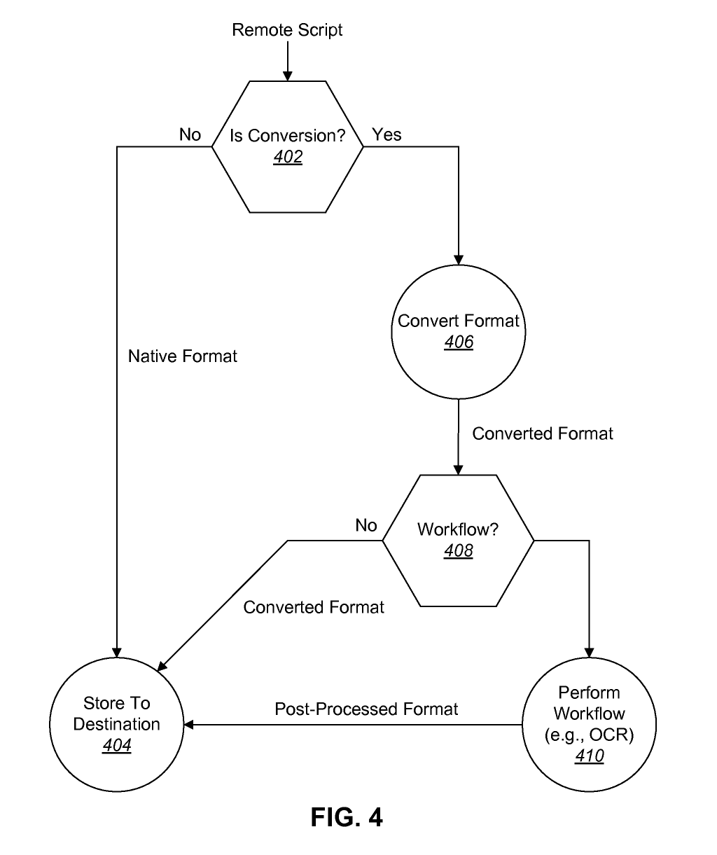

Referring now to FIG. 4, processing a script 216 that includes file transfer instructions may involve determining 402 whether the script 216 indicates that the file is to be converted from its native format into a different format. If the script 216 does not indicate that any file conversion is to take place, the despooling component 114 may store 404 the file to a destination on the local client 102, as discussed above. If the script 216 indicates that file conversion is to take place, the despooling component 114 may convert 406 the file from a native format to a different format (which may be specified in the script 216).

The despooling component 114 may also determine 408 whether additional workflow processing is to take place on the file. If it is determined 408 that no additional workflow processing is to take place, the despooling component 114 may store 404 the file to a destination on the local client 102, as discussed above. If it is determined 408 that additional workflow processing is to take place, the despooling component 114 may perform 410 the additional workflow processing that is specified. The file may then be stored 404 to a destination on the local client 102, as discussed above. Additionally, even if no format conversion 402 is to be performed, the despooling component 114 may also determine 408 whether additional workflow processing is to take place on the native file.

Another example of an operation that may be performed by the script interpreting despooler component 114 is reconfiguring the print settings of an installed printer on the local client 102. In this embodiment, the management/job generation process 110 on the remote device 108 may be used to identify the installed printer to reconfigure and the reconfigured settings. The local client's 102 installed printer may be identified by any suitable means, such as manual entry, discovery by enumeration of installed printers on the local client 102, etc. When the generation process 110 is used to enumerate the installed printers on the local client 102, the generation process 110 may obtain the enumeration by querying the local client's print spooler 112. Alternatively, the generation process 110 may send an additional job script to the local client's script interpreting despooler 114, which may respond back with the local client's 102 installed printers.

The script 216 may specify reconfiguring any number of parameters, such as the default settings for copies, collation, duplex, booklet, N-up, binding edge, staple, punch, fold, resolution, half-toning, paper size, tray, type, output bin, scan destination profile, fax number, cover page, etc. The generation process 110 may determine the options and associated settings supported by the installed printer by any suitable means. For example, the options and associated settings may be predetermined (e.g., they may be stored in a printer model database (PMDB), where they may be accessed by the generation process 110). Alternatively, the options and associated settings may be determined by generating a job script which requests the local client's script interpreting despooler 114 to respond back with the installed printer's options/settings. The script interpreting despooler component 114 may then have the capability to interpret and execute the above functions, such as determining that the installed printer exists, determining that the option(s) and/or setting(s) is/are valid, converting the specified option(s)/setting(s) into device (installed printer) specific settings, reconfiguring the option(s)/setting(s) (e.g., printer spooler API calls), auditing and accounting, notifying the remote device on any failures, and so forth.

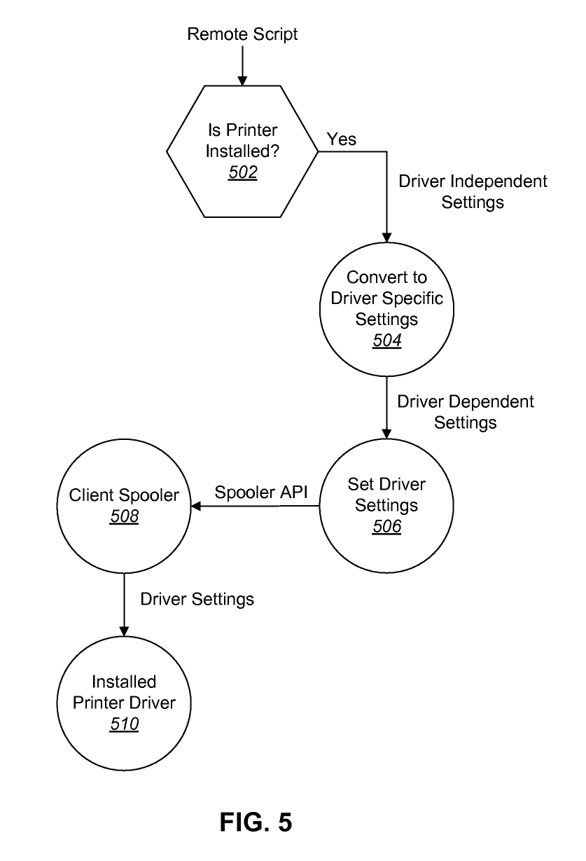

Referring now to FIG. 5, processing a script 216 that includes instructions to reconfigure print settings of an installed printer on the local client 102 may involve determining 502 whether the printer is installed. If it is determined 502 that the printer is installed, the despooler component 114 may convert 504 the driver independent settings to driver dependent settings. The despooler component 114 may then set 506 driver settings. This may be done by making printer spooler API calls to a client spooler 508. The client spooler 508 may reconfigure the settings of the installed printer driver 510.

Another example of an operation that may be performed by the script interpreting despooler component 114 is reconfiguring the spooler settings of an installed printer on the local client 102. In this embodiment, the management/job generation process 110 on the remote device 108 may be used to identify the installed printer to reconfigure and the reconfigured settings. The local client's 102 installed printer may be identified by any suitable means, such as those described above.

The script 216 may specify reconfiguring any parameter, such as the communication address and port, port monitor, priority, printer driver, print processor, when to despool, etc. The generation process 110 may determine the options and associated settings supported by the print spooler 112 by any suitable means. For example, the options and associated settings supported by the print spooler 112 may be predetermined. Alternatively, the generate process 110 may generate a job script which requests the local client's script interpreting despooler 114 to respond back with the print spooler's 112 options/settings.

The script interpreting despooler component 114 may have the capability to interpret and execute the above functions, such as determining that the installed printer exists, determining that the option(s) and/or setting(s) is/are valid, converting the specified option(s)/setting(s) into spooler-specific settings, reconfiguring the option(s)/setting(s) (e.g., printer spooler API calls), auditing and accounting, notifying the remote device on any failures, and so forth.

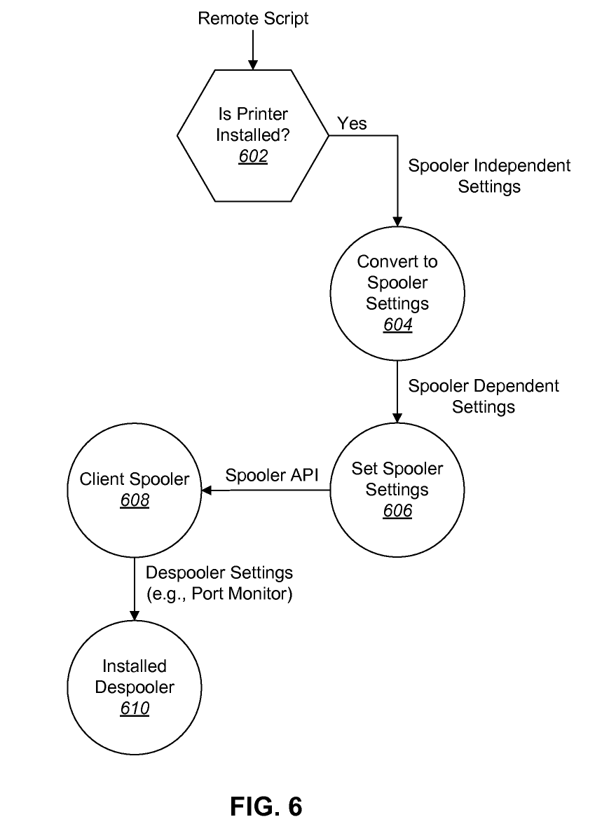

FIG. 6 illustrates how a script 216 that includes instructions to reconfigure the spooler settings of an installed printer on the local client 102 may be processed. The despooler component 114 may determine 602 whether the printer is installed. If it is determined 602 that the printer is installed, the despooler component 114 may convert 604 spooler independent settings to spooler dependent settings. The despooler component 114 may set 606 spooler settings. This may be done by making printer spooler API calls to a client spooler 608. The client spooler 608 may reconfigure the settings of either or both the client spooler 608 or the installed despooler 610.

Another example of an operation that may be performed by the script interpreting despooler component 114 is distributing a printer driver for a locally or network connected printer and installing a corresponding installed printer. In this embodiment, the management/job generation process 110 on the remote device 108 may be used to identify the connected printer and associated printer driver. This may be done by any means, such as manual entry, discovery, etc. In the case of discovery, an operator may initiate the discovery (e.g., network sweep) or the device may register itself (e.g., SLP, SSDP) either directly with the generation process 110 or indirectly with a directory service (e.g., Printer Directory Service).

The generation process 110 may either embed the printer driver or embed a reference to the printer driver (e.g., URL, network path, ID to locate from a common driver repository either locally on the local client 102 or within the network domain). The script 216 may also include configuration parameters, such as default print settings, configuration of the printer (e.g., optional components, trays, etc), port monitor, spooler settings, etc. The script interpreting despooling component 114 may then have the capability to interpret and execute the above functions, such as extracting or obtaining the printer driver, creating an installed printer (e.g., Win32 AddPrinter( ) API), configuring the default settings, configuring the printer's configuration, registering the installed printer in a directory service, auditing and accounting, notifying the remote device 108 on failure, etc.

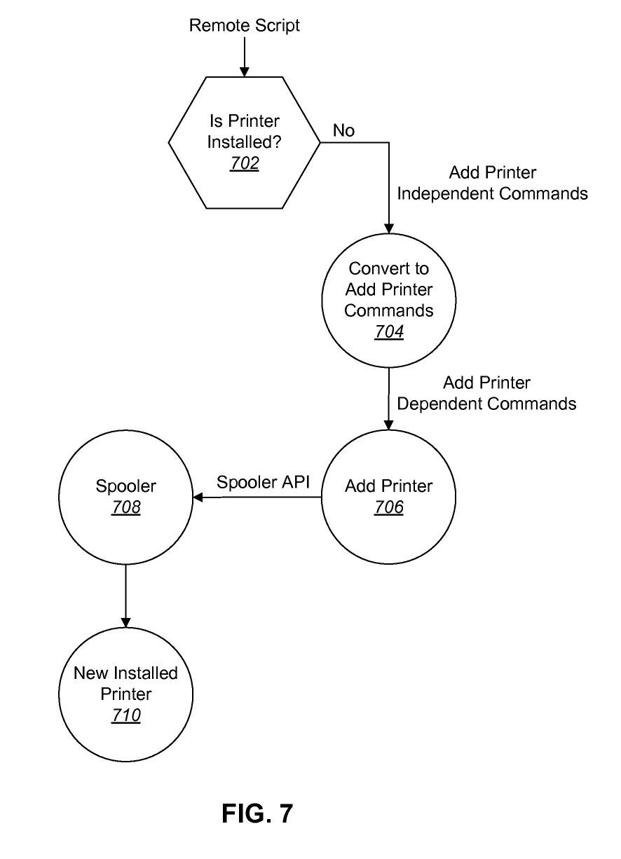

Referring now to FIG. 7, distributing a printer driver for a locally or network connected printer and installing a corresponding installed printer may involve determining 702 whether the printer is installed. If it is determined 702 that the printer is not installed, the despooler component 114 may convert 704 add printer independent commands into add printer dependent commands. The despooler component 114 may then add 706 the printer. This may be done by making spooler API calls to a spooler 708. The spooler 708 may then add the newly installed printer 710.

Another example of an operation that may be performed by the script interpreting despooler component 114 is scanning to a destination on the local client 102. In this embodiment, the remote device 108 may include a scanner subunit. Examples of scanner subunits include a platen scanner, a document scanner, a barcode scanner, a scan server, a facsimile device, an Internet fax utility, etc. The generation process 110 may create a job script 216 that contains the scanned image data and associated parameters. The scanned image data may be embedded in the script 216. Alternatively, a reference to the scanned image data may be embedded in the script 216. The parameters may specify any post-processing operation, such as the destination, format conversion, compression, re-encoding, encryption, annotation, Bates stamping, OCR, etc.

The script interpreting despooling component 114 may then have the capability to interpret and execute the above functions, such as extracting the scanned image data, pulling the scanned image data (such as from a network file path or HTTP or SOAP/DIME request), compressing or decompressing the scanned image data, encrypting or decrypting the scanned image data, converting and/or re-encoding the scanned image data, storing the scanned image data at the specified location, optical character recognition (OCR) and indexing, annotation and time stamping, auditing and other logging, accounting, etc.

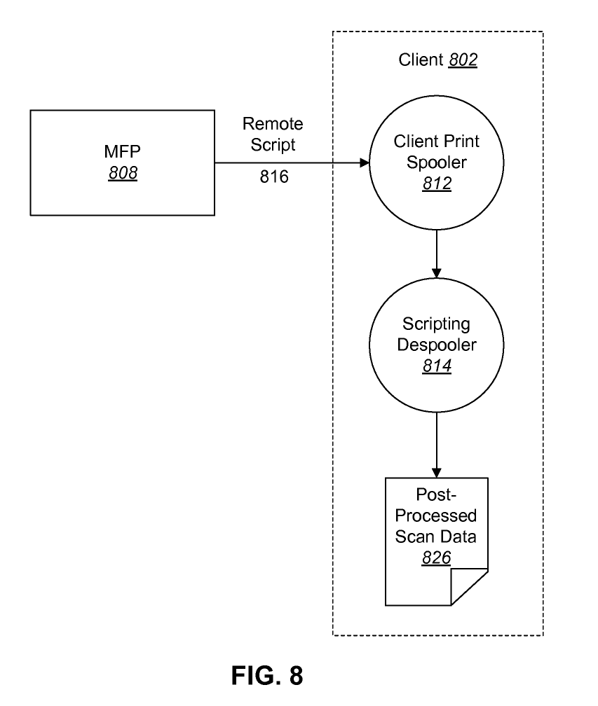

FIG. 8 illustrates how a script 816 that includes instructions to scan to a destination on a local client 802 may be processed in accordance with an embodiment. A process 110 on a remote device 808, such as an MFP 808, may generate a script 816 and send the script 816 to the local client 802 as an imaging job. A spooler 812 on the local client 802 may then despool the management/job script 816 to a script interpreting despooling component 814. The script interpreting despooling component 814 may interpret and execute the instructions in the script 816, which may include instructions obtain scanned image data and perform post-processing operations on the scanned image data, thereby generating post-processed scan data 826.

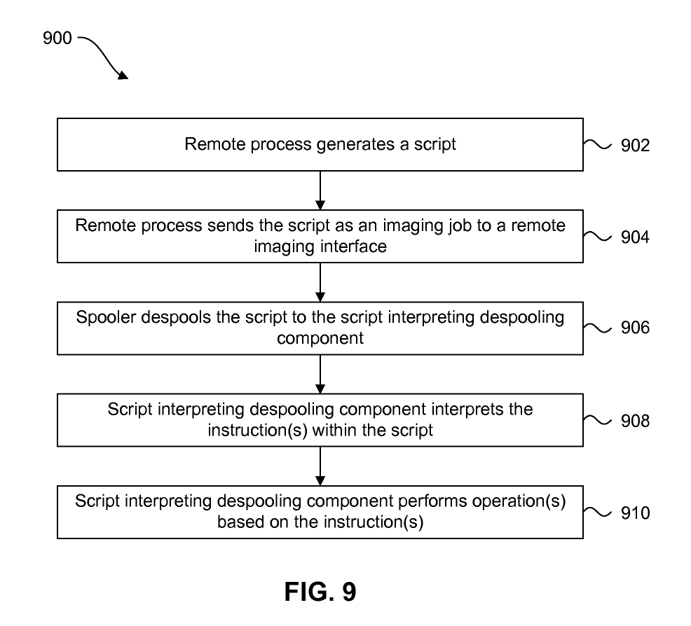

FIG. 9 illustrates a method 900 for remotely configuring a remote interface to an imaging device in accordance with an embodiment. A process 110 on a remote device 108 may generate 902 an imaging management or job script 216. The script 216 may include instructions for performing at least one operation on a local client 102. The process 110 may send 904 the script 216 as an imaging job to a remote imaging interface 104 on the local client 102. Instead of the remote imaging interface 104 being connected to a physical imaging device, the remote imaging interface 104 may be connected to a despooling component 114 (e.g., a specialized print processor or port monitor), which may be configured to perform management and imaging operations locally on the local client 102.

A spooler 112 on the local client 102 may despool 906 the script 216 to the script interpreting despooling component 114. The script interpreting despooling component 114 may then interpret 908 the script and perform 910 the associated management/job operation(s) on the local client 102 based on the interpreted instructions. As discussed above, these operations may include installing a new imaging device (e.g., printer), reconfiguring an existing installed imaging device (e.g., changing default settings), reconfiguring the spooling/despooling settings of a port monitor associated with an existing installed imaging device, receiving scanned image data and performing one or more post-processing operations (e.g., workflow), file transfer, loading an address book, and so forth.

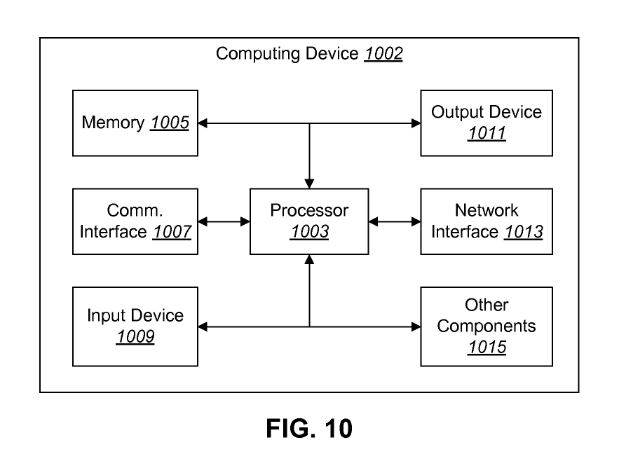

FIG. 10 illustrates various components that may be utilized in a computing device 1002 (such as a remote device 108 and/or a client device 102) in accordance with an embodiment. The illustrated components may be located within the same physical structure or in separate housings or structures.

The computing device 1002 may include a processor 1003 and memory 1005. The processor 1003 may control the operation of the computing device 1002 and may be embodied as a microprocessor, a microcontroller, a digital signal processor (DSP) or other device known in the art. The processor 1003 typically performs logical and arithmetic operations based on program instructions stored within the memory 1005. The instructions in the memory 1005 may be executable to implement the methods discussed above. For example, the processor 1003 may execute the instructions in the memory 1005 to perform the steps of the method 900 of FIG. 9, such as generating 902 a script 216, sending 904 the script 216 as an imaging job, interpreting 908 instructions within the script 216, and so forth.

The computing device 1002 may also include one or more communication interfaces 1007 and/or network interfaces 1013 for communicating with other electronic devices. For example, the remote device 108 and the client device 102 may communicate with one another via the communication interface 1007 and/or via the network interface 1013. The communication interface(s) 1007 and the network interface(s) 1013 may be based on wired communication technology, wireless communication technology, or both.

The computing device 1002 may also include one or more input devices 1009 and one or more output devices 1011. The input devices 1009 and output devices 1011 may facilitate user input. Other components 1015 may also be provided as part of the computing device 1002.

FIG. 10 illustrates only one possible configuration of a computing device 1002. Various other architectures and components may be utilized in accordance with the disclosed embodiments.

Other embodiments include the spooling and despooling subsystems of various operating systems, including (but not limited to) the Microsoft Windows® operating systems, Apple Macintosh operating systems, Linux operating system, System V Unix operating systems, BSD Unix operating systems, OSF Unix operating systems, Sun Solaris operating systems, HP/UX operating systems, IBM Mainframe MVS operating system, etc.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for remotely configuring a remote interface to an imaging device, comprising:
a remote process generating a script, wherein the script comprises instructions for performing at least one operation on a local client;
the remote process sending the script as an imaging job to a remote imaging interface, wherein the remote imaging interface is installed on the local client, and wherein the remote imaging interface is associated with a script interpreting despooling component;
a spooler on the local client despooling the script to the script interpreting despooling component, and
the script interpreting despooling component interpreting the instructions within the script and performing the at least one operation based on the interpreted instructions.

2. The method of claim 1, wherein the remote process is running on a remote device that is separate from the local client.

3. The method of claim 1, wherein the remote process sending the script to the remote imaging interface comprises:
the remote process spooling the script to an imaging device that is installed on the remote device, wherein the imaging device is connected to the remote imaging interface on the local client; and
a spooler on the remote device despooling the script to the remote imaging interface on the local client.

4. The method of claim 1, wherein the remote process sending the script to the remote imaging interface comprises the remote process connecting directly to a spooler on the local client.

5. The method of claim 1, wherein the at least one operation comprises transferring a file to the local client.

6. The method of claim 1, wherein the at least one operation comprises reconfiguring settings of an installed imaging device on the local client.

7. The method of claim 6, further comprising:
the remote process identifying the installed imaging device; and
the remote process identifying the settings of the installed imaging device to be reconfigured.

8. The method of claim 1, wherein the at least one operation comprises reconfiguring spooler settings of an installed imaging device on the local client.

9. The method of claim 8, further comprising:
the remote process identifying the installed imaging device; and
the remote process identifying the spooler settings of the installed imaging device to be reconfigured.

10. The method of claim 9, wherein the remote process identifying the spooler settings to be reconfigured comprises the remote process generating an additional script which requests that the script interpreting despooling component respond with available spooler settings.

11. The method of claim 1, wherein the at least one operation comprises installing an imaging device and an associated imaging device driver on the local client.

12. The method of claim 11, further comprising:
the remote process identifying the imaging device to be installed; and
the remote process identifying the associated imaging device driver.

13. The method of claim 1, wherein the at least one operation comprises receiving scanned image data.

14. The method of claim 13, wherein the at least one operation further comprises performing a post-processing operation on the scanned image data.

15. The method of claim 1, wherein the imaging job is sent to a network queue on the local client, wherein the network queue is associated with the remote imaging interface.

16. The method of claim 1, further comprising the remote process determining capabilities of the script interpreting despooling component.

17. The method of claim 1, wherein the script interpreting despooling component comprises a specialized print processor.

18. The method of claim 1, wherein the script interpreting despooling component comprises a specialized port monitor.

19. A system for remotely configuring a remote interface to an imaging device, comprising:
a remote imaging interface installed on a local client;
a script interpreting despooling component associated with the remote imaging interface;
a remote process on a remote device that is configured to generate a script and to send the script as an imaging job to the remote imaging interface, wherein the script comprises instructions for performing at least one operation on the local client, wherein the script interpreting despooling component is configured to interpret the instructions within the script and perform the at least one operation based on the interpreted instructions; and
a spooler on the local client that is configured to despool the script to the script interpreting despooling component.

20. A computer-readable medium comprising executable instructions for implementing a method for remotely configuring a remote interface to an imaging device, the method comprising:
a remote process generating a script, wherein the script comprises instructions for performing at least one operation on a local client;
the remote process sending the script as an imaging job to a remote imaging interface, wherein the remote imaging interface is installed on the local client, and wherein the remote imaging interface is associated with a script interpreting despooling component;
a spooler on the local client despooling the script to the script interpreting despooling component, and
the script interpreting despooling component interpreting the instructions within the script and performing the at least one operation based on the interpreted instructions.
